(19) United States
(12) Patent Application Publication
(10) Pub. No.: US 2006/0220373 A1
(43) Pub. Date: Oct. 5, 2006

(54) Expanded content label and related method of manufacture

(75) Inventor: Bryan T. Baker, Bartlett, TN (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: CCL Label, Inc.

(21) Appl. No.: 11/098,869

(22) Filed: Apr. 5, 2005

(51) Int. Cl. B42D 15/00

(52) U.S. Cl. 283/81

(57) ABSTRACT

An expanded content label including a pull-out panel. The label includes an expanded content device having a first panel, a second panel and an intermediate panel. The intermediate panel is slideable relative to at least the second panel, and at least partially accessible through an aperture defined in one of the other panels and/or a fold line. An overlaminate is secured over the device and includes a margin which can secure the device to an optional base label. A method also is provided including: providing an expanded content device which includes first, second and intermediate panels, cutting along and/or near a fold line between the first and second panels; and cutting the first panel and intermediate panel so that a portion of the intermediate panel can be accessed through the aperture.

### BACKGROUND OF THE INVENTION

The present invention relates to labels, and more particularly to an expanded content label and a method for making the same.

Generally, an expanded content label is a label that provides an increased amount of printed information that can be included with a product or its packaging. ECLs increasingly are used to replace leaflets, booklets, manuals, tags and other materials otherwise packaged with products to provide information about those products.

A conventional ECL includes a multi-page booklet that is secured directly to the product or to a base label which is secured to the product. Information about the product is printed on or in the booklet. Different types of information about the product, for example warnings and use instructions, can be printed on different pages throughout the booklet. Additionally, information can be printed in different languages in different sections throughout the booklet so that the product can be distributed in countries where different languages are used, or to provide product information to a multilingual consumer base. In such multilingual ECL booklets, the first few pages of the booklet are printed with information in a first language, for example, English. The remaining pages are printed with identical information in a second language, for example, Spanish.

Although conventional ECLs can provide additional information and/or multilingual information, they suffer several shortcomings. As one example, to access certain information about a product, or to access information in a specific language, a user must thumb through multiple pages of the booklet to find the text that they require. This can be time consuming and something frustrating. As another example, some consumers may be offended when information in their language is printed in the last pages of the booklet, rather than on the first pages. This can alienate the consumer, and possibly prevent them from purchasing the associated products. As another example, some consumers desire to remove the information that is not in their preferred language from the ECL. Conventional ECLs fail to provide this feature, and therefore some users resort to tearing out excess information from the ECL. This can lead to damage of the ECL, or can render it aesthetically unappealing.

### SUMMARY OF THE INVENTION

The aforementioned problems are overcome in the present invention wherein an expanded content label includes an expanded content device including a first panel, a second panel and an intermediate panel, and further defines an aperture. The intermediate panel is slidable relative to at least the second panel and accessible through the aperture. An overlaminate is secured to the expanded content device, and includes a margin with an adhesive thereon extending beyond a side of the expanded content device for optionally securing the expanded content device to an article or other label component.

In another embodiment, at least a portion of the intermediate panel is of a width that is less than a width of the aperture. The portion can slide through the aperture so that the intermediate panel is movable between a stored mode and an accessed mode. In the accessed mode, information optionally printed on the intermediate panel is exposed.

In a more specific embodiment, the expanded content label includes a base label to which the expanded content device is secured. The margin of the overlaminate can include an adhesive that secures the label to the base label. Additional margins can be supplied to provide additional securement to the base label.

A method for manufacturing the label is also provided. The method includes: cutting label material to form an aperture across at least a portion of a width of the material; cutting the material so that a portion is of a second width less the first width; folding the material to form a first panel, a second panel and intermediate panel, the intermediate panel positioned between the first panel and the second panel, the first panel and second panel connected by a fold line, the fold line being adjacent and/or near the aperture; cutting the second panel and the intermediate panel so that the intermediate panel is free to slide relative to the second panel. An optional step includes securing an overlaminate to the first panel and/or another portion of the expanded content device formed by the first panel, second panel and intermediate panel. Another optional step includes securing the expanded content device to a base label via a margin of the overlaminate extending beyond the expanded content device.

The present invention provides a simple and inexpensive expanded content label that readily provides multiple information fields that are easy to access and readily provide additional information. Where the information fields on the panels of the expanded content device are provided in different languages, products labeled with the present expanded content label are readily accepted in multilingual cultures and by multilingual consumer bases.

These and other objects, advantages and features of the invention will be more readily understood and appreciated by reference to the detailed description of the invention and the drawings.

### BRIEF DESCRIPTION OF THE DRAWINGS

FIG. 1 is a perspective view of an expanded content label according to the present invention;

FIG. 2 is a perspective view of an opened expanded content label;

FIG. 3 is a perspective view of an expanded content device of the expanded content label;

FIG. 4. is a perspective view of a process for manufacturing the expanded content label; and

FIG. 5 is a perspective view of a first alternative embodiment of the expanded content label.

### DETAILED DESCRIPTION OF THE INVENTION

I. Overview

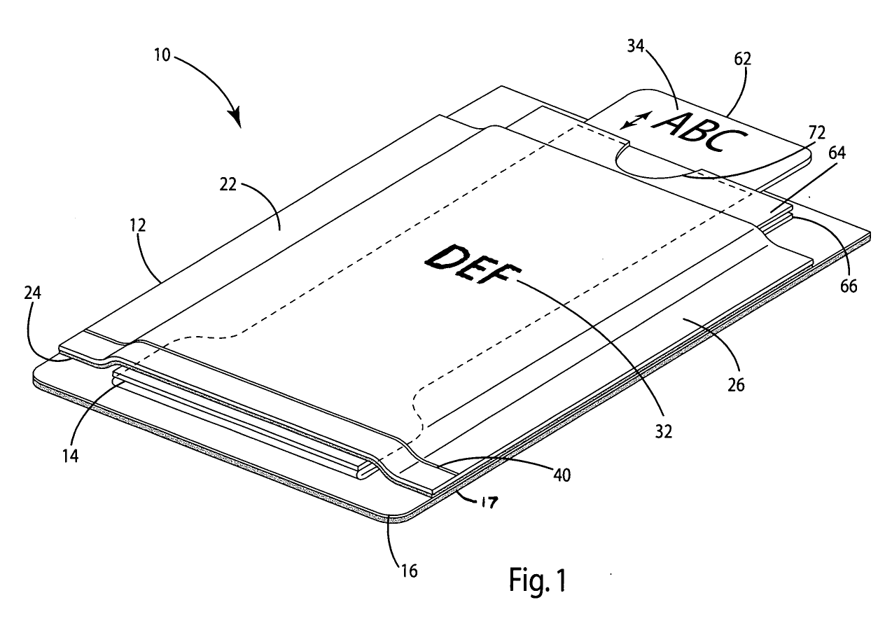

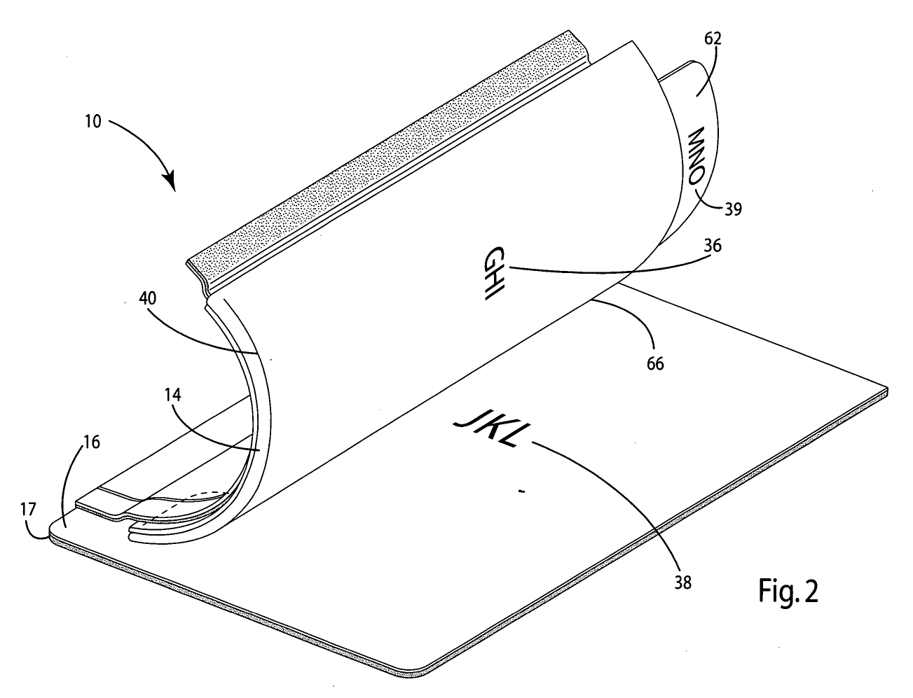

A first embodiment of the expanded content label (ECL) of the present invention is illustrated in FIGS. 1 and 2 and generally designated 10. The label includes an overlaminate 12 adhered over an expanded content device 14 to secure the device to an optional base label 16. Where the base label is not included, the overlaminate can secure the device to an article via adhesive 24. The illustrated ECL 10 includes information fields 32 and 34, which can be included on the overlaminate 12 and/or on the panels of the expanded content device 14. The ECL can include a cut 40 which penetrates at least the first panel 64 and the intermediate panel 62, and optionally the overlaminate 12 and second panel 66.

As shown, the intermediate panel 62 is physically separated from the second panel 66 along the cut 40. The intermediate panel 62 thus is free to slide relative to the second panel 66 and/or first panel 64 to a stored mode (shown in broken lines) and to an accessed mode (shown in full lines). With this construction, the intermediate panel 62 can be accessed by a user to expose information field 34. In one example, the ECL information field 32 can include product instructions written in English, and the information field 34 can include identical instructions written in Spanish. With such an ECL, a Spanish-speaking user can easily find and access the information field 34.

As will be appreciated, multiple expanded content devices 14 can be included in a single expanded content label 10 to provide multiple, accessible intermediate panels and the information associated with the same. The expanded content devices can be offset so that a portion of one is above another, thereby providing a user with a view of, and access to, the multiple devices.

II. Construction

With reference to FIGS. 1 and 2, the construction of the ECL and its components will be described in more detail. The base or base label 16 includes first and second sides. The second side, or underside, is coated with an adhesive layer 17, which can cover the entire underside or be applied in a pattern on the underside. As noted above, the base label may be entirely absent from the ECL 10 without significantly altering its performance. The expanded content label, the base label and any other components can be constructed from a variety of materials, including paper, plastic, foil, metals, and the like.

The overlaminate 12 includes an adhesive 13 on its underside. The overlaminate is secured over the expanded content device 14 to secure it to the base label 16. More specifically, the overlaminate as shown extends beyond the sides of the expanded content device 14 at margins 22 and 26. In those margins, the adhesive 24 secures the overlaminate to the base layer 16. In this manner, the expanded content device is sandwiched between the base and the overlaminate. Optionally, the adhesive on the margins can be a releasable and/or resealable adhesive so that those portions can be easily removed from the base 16. The base can also optionally be coated with a release composition on one side corresponding to the location of one or both margins to facilitate release of the overlaminate from the base 16. Although the overlaminate as shown in the figures is transparent, it can be opaque or colored as desired. Furthermore, the dimensions of the overlaminate relative to the ECL can be altered as desired.

The expanded content device 14 shown in FIGS. 1-3 is a multiple panel device with information optionally placed on or in various parts. For example, the first panel 64 can include an information field 32 that is visible through the overlaminate. This information field can alternatively be printed on the overlaminate. The intermediate panel 62 includes information field 34 printed on a front side thereof, but as shown in FIG. 2, can also include another information field 39 on its rear side. FIG. 2 also illustrates that where the ECL includes a base 16, and the expanded content device is openable relative the base, an additional information field 38 can be included on the base label. In such an embodiment, the second panel 66 also can include an information field 36.

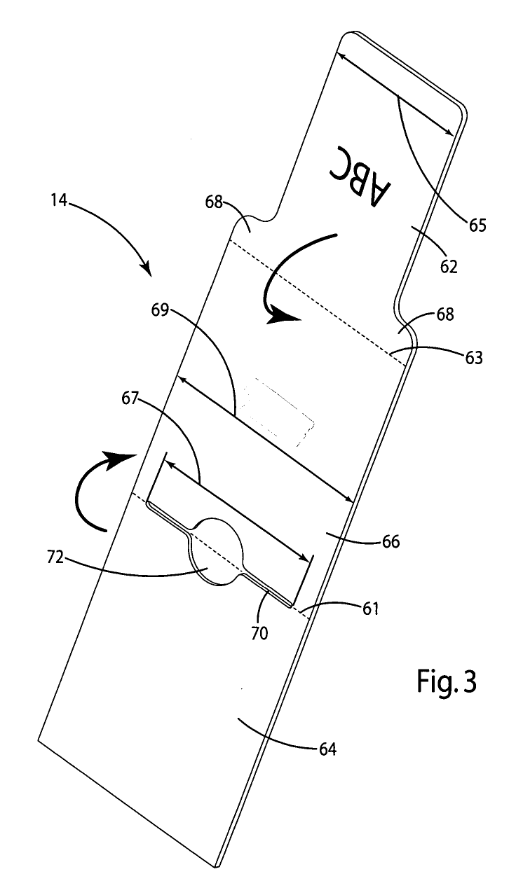

With reference to FIG. 3, the expanded content device 14 is constructed from an elongated piece of label material generally having a first width 69. The intermediate panel 62 and the second panel 66 are connected at a first fold line 63. The first panel 64 is connected to the second panel 66 at a second fold line 61. The intermediate panel can include a portion of a width 65, which is less than the width 69. An aperture 70, also referred to as a cut, is defined along and/or adjacent or near the fold line 61. This aperture can be in the form of a very narrow slit formed along the fold line 61, and defined by or in the first panel 64, the second panel 66, or both. The aperture 70 can be of a width 67 that is at least as great as the width 65. An access recess 72 can further be defined in the first panel 64 and second panel 66 and contiguous with the aperture 70.

As shown by the arrows in FIG. 3, the intermediate panel 62 is folded over toward the second panel 66. The first panel 64 is folded over both the intermediate panel and second panel 66 as shown with the arrows. When folded in this manner, the portion of intermediate panel 62 of width 65 is aligned with the aperture 70. Additionally, part of the intermediate panel 62 is accessible by a user through the access recess 72.

In the embodiment shown in FIG. 3, the lower portion of the intermediate panel 62 is of width 69, which is greater than width 65 of that panel. Accordingly, the lower portion of the intermediate panel includes a base 68.

With further reference to FIG. 1, the expanded content device 14 is cut along the cut 40. This cut physically separates the intermediate panel 62 from at least the second panel 66, or at least forms a perforation between the panels. Accordingly, the intermediate panel 62 is free or can be freed to slide relative to the second panel and/or first panel, and optionally between the first 64 and second 66 panels.

In use, a user can contact the intermediate panel 62 through the access recess 72, and slide that panel in the direction of the arrows to selectively view information field 34. Where the intermediate panel includes a base 68, that base acts as a stop to prevent intermediate panel 62 from being fully removed from the expanded content device. For example, the base 68 engages the portion of the panels 66 and 64 that extend beyond the aperture 70, and prevents the intermediate panel 62 from being withdrawn.

Additionally, where the ECL 10 includes a base label and a releasable overlaminate, a user can open the expanded content device relative to the base layer 16 and expose information fields 36, 38 and 39. This provides access to an amount of information.

III. Method of Manufacture

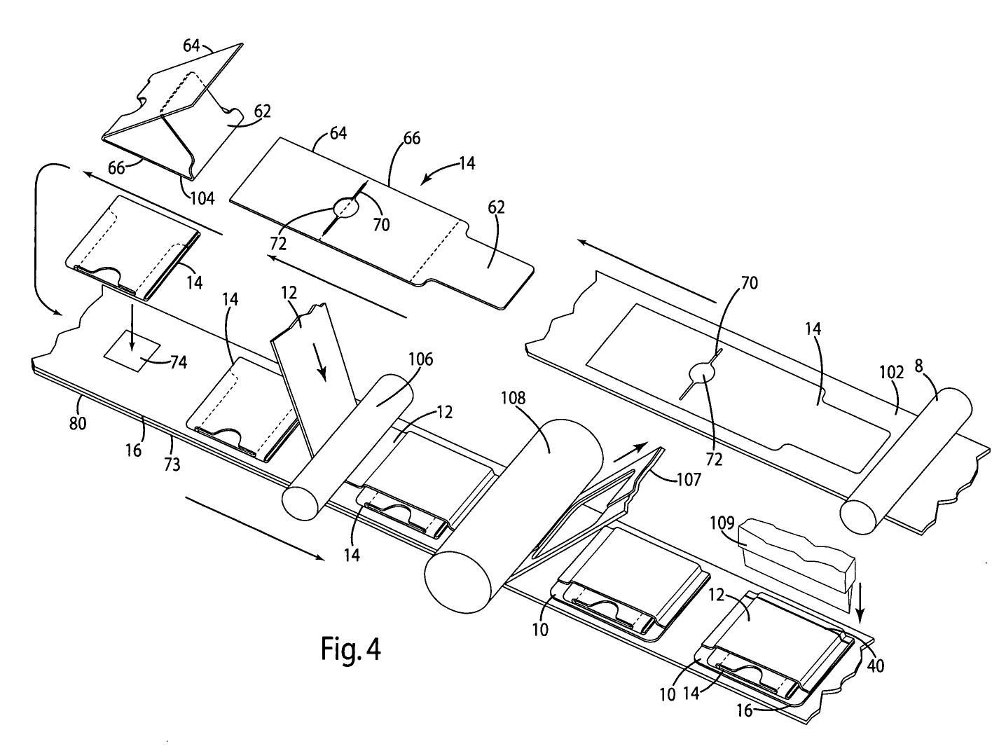

A method of manufacturing an embodiment of the ECL of the invention will now be described with reference to FIG. 4. Although it is possible to produce labels one at a time, the method described here produces multiple labels on a continuous web of release material. The method begins with creation of the expanded content device 14. An elongate piece of label material 8 is fed through a die cutting machine 102. The die cutting machine cuts the material 8 to outline the expanded content device 14. The die cut machine 102 can also simultaneously create aperture 70 and access recess 72.

The outlined expanded content device 14 is folded in step 104 with conventional machinery. Intermediate panel 62 is folded toward the second panel 66, and the first panel 64 is folded over the intermediate panel 62. Accordingly, the intermediate panel 62 is sandwiched between the first panel 64 and second panel 66.

In the folded configuration, the expanded content device 14 is applied with an adhesive 74 to a base 16. The base can be in the form of a continuous web and further secured to a release liner 80. In an alternative construction, the base layer 16 can be entirely absent such that the expanded content device 14 is secured directly to the release liner 80. The web 73, including the liner, base and expanded content devices, is advanced to an overlaminate applying station 106. There, overlaminate 12 is adhered over the expanded content device 14 to further secure it to the base 16.

At station 108, the overlaminate 12 and base label material 16 are cut to outline the footprint of individual ECLs 10. The waste matrix 107 is removed from the release liner 80. Additional cutting machinery 109 cuts the cut line 40 through the overlaminate 12, and at least the first panel 64 and intermediate panel 62 of the expanded content device 14. Accordingly, the intermediate panel 62 is freed from the second panel 66 so that it can be moved. The continuous web 73 can be wound into a spool for further distribution. Individual ECLs can be applied to articles from the web using conventional machinery.

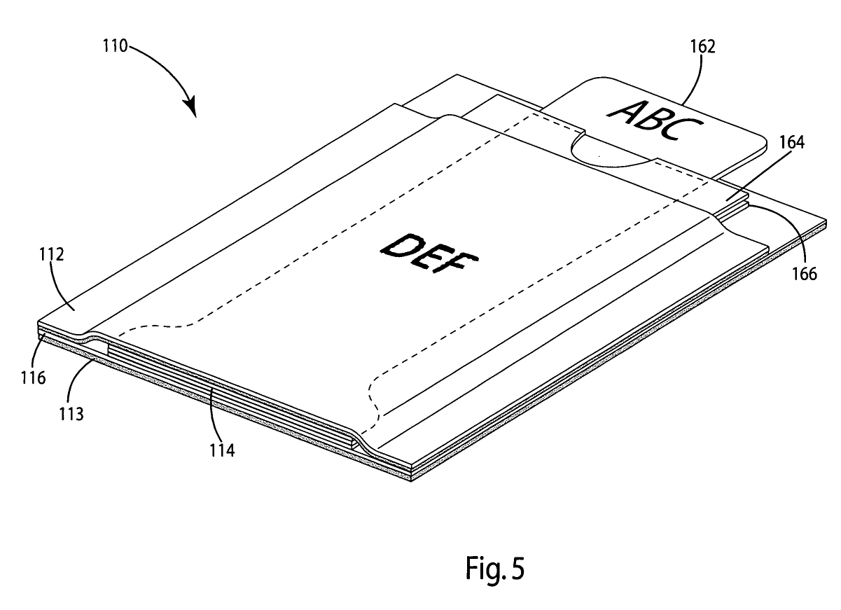

The aforementioned process may be modified to accommodate various embodiments of the expanded content label contemplated by the present invention. One such alternative embodiment of the expanded content label is shown in FIG. 5 and designated 110. That embodiment includes the components of the embodiment shown in FIG. 1, however, the ECL 110 is cut so that no excess material is included with the ECL after the cut. Specifically, when the footprint of the label is cut at station 108 in FIG. 4, the die also cuts along the bottom portion of the expanded content device 114 to release the intermediate panel 162 from the first panel 164 and second panel 166. Accordingly, with this embodiment, the extra cutting step at station 109 can be eliminated.

The above descriptions are those of the preferred embodiments of the invention. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

1. An expanded content label comprising:
an expanded content device including a first panel, a second panel, and an intermediate panel, the intermediate panel including at least a portion having a first width and a first information field, the first panel and second panel connected along a first fold line, the first panel folded over the intermediate panel and the second panel so that the intermediate panel is positioned between the second panel and the second panel, the intermediate panel being slidable relative to the second panel, at least one of the first panel, second panel, and fold line defining an aperture of a second width, the second width being less than the first width so that at least the portion of the intermediate panel of the first width is slideable through the aperture to expose the first information field; and
an overlaminate adhered over the expanded content device, the overlaminate including a first margin that extends beyond a side of the expanded content device, the first margin including an adhesive.

2. The expanded content label of claim 1 wherein the intermediate panel is positionable between a stored mode and an accessed mode, wherein in the stored mode, the information field is at least partially hidden from view, wherein in the accessed mode, the information field is at least partially visible.

3. The expanded content label of claim 2 wherein at least one of the first panel, second panel, and fold line define an access recess adjacent the aperture, whereby a user can contact the intermediate panel and move the intermediate panel to the accessed mode.

4. The expanded content label of claim 1 comprising a base label including a first side and a second side, the overlaminate first margin adhered to the first side, the second side including an adhesive.

5. The expanded content label of claim 1 wherein the overlaminate includes a second margin, the first and second margins each respectively extending beyond opposing sides of the expanded content device.

6. The expanded content label of claim 5 wherein each of the first and second margins include an adhesive.

7. The expanded content label of claim 6 comprising a base label, the first margin releasably adhered to the base label, wherein the expanded content device is openable to an open mode so that a user can view the first panel.

8. An expanded content label comprising:
an expanded content device including a first panel, a second panel, and an intermediate panel, the first panel folded over the intermediate panel and the second panel along a fold line between the first and second panels so that the intermediate panel is positioned between the first panel and the second panel, the intermediate panel being slidable from an at least partially stored mode to an at least partially accessed mode through an aperture defined by at least one of the first panel, second panel and fold line;
a base label; and
an overlaminate adhered over the expanded content device and including an adhesive securing the expanded content device to the base label.

9. The expanded content label of claim 8 wherein the aperture is defined along the fold line and of a first width, the aperture including an access recess further defined in at least one of the first panel and the second panel, wherein a user can contact the intermediate panel through the access recess and move the intermediate panel to the accessed mode.

10. The expanded content label of claim 9 wherein the overlaminate includes a first margin and a second margin, each margin extending beyond the expanded content device and adhered to the base label.

11. The expanded content label of claim 10 wherein the second panel includes an information field, wherein the first margin is releasably adhered to the base label so that a user can open the expanded content device to review the information field.

12. The expanded content device of claim 9 wherein the intermediate panel includes a portion that is more narrow than the aperture.

13. A method comprising:
providing an elongate piece of label material having a length and a first width;
cutting the piece to form an aperture across at least a portion of the first width;
cutting the piece so that a portion of the piece is of a second width less than the first width;
folding the piece to form a first panel, a second panel and an intermediate panel, the first panel and second panel connected by a first fold line, the aperture being at least one of adjacent the first fold line and along the first fold line, the second panel and the intermediate panel connected by a second fold line, the intermediate panel including the portion of the piece of the second width, the intermediate panel positioned between the first panel and the second panel; and
cutting the second panel and the intermediate panel so that the intermediate panel is free to slide relative to at least the second panel.

14. The method of claim 13 comprising securing an overlaminate to the first panel, the overlaminate extending beyond the first panel to form a margin, the margin including an adhesive.

15. The method of claim 13 wherein the first panel, second panel and intermediate panel form an expanded content device, comprising releasably securing the expanded content device to a release liner.

16. The method of claim 14 wherein the margin adhesive releasably adheres to the release liner.

17. The method of claim 14 wherein the overlaminate, first panel and second panel are cut.

18. The method of claim 13 wherein the first panel, second panel and intermediate panel form an expanded content device, comprising securing the expanded content device to a base label including a first side adjacent the expanded content device and a second side, opposite the expanded content device, the second side including an adhesive.

19. The method of claim 18 comprising securing the second side to a release liner.

20. The method of claim 13 wherein after cutting the second panel and the intermediate panel, the intermediate panel is free to slide between the first panel and the second panel.
